(19) United States
(12) Patent Application Publication
(10) Pub. No.: US 2009/0112042 A1
(43) Pub. Date: Apr. 30, 2009

(54) Decontamination method of metal surface contaminated by radioactive element

(75) Inventors: Jen-Chieh Chung, Longtan Shiang (TW); Che-Nan Chen, Longtan Shiang (TW); Kon-Min Lin, Zhongli City (TW); Tsong-Yang Wei, Taipei City (TW)

Correspondence Address: TROXELL LAW OFFICE PLLC, 5205 LEESBURG PIKE, SUITE 1404, FALLS CHURCH, VA, 22041, US

(73) Assignee: ATOMIC ENERGY COUNCIL - INSTITUTE OF NUCLEAR ENERGY RESEARCH, Taoyuan (TW)

(21) Appl. No.: 11/976,442

(22) Filed: Oct. 24, 2007

(51) Int. Cl. G21F 9/16

(52) U.S. Cl. 588/6

(57) ABSTRACT

A decontamination gel is obtained to be spayed on a contaminated material. Places of contaminations of Co, Cs and Sr are shown by the gel. Then the gel is dried up in the air to form a film. Thus, the contaminations are cleaned by removing the film.

### FIELD OF THE INVENTION

The present invention relates to a decontamination method; more particularly, relates to mixing a blend of polymers, characteristic additives and a decontamination reagent to obtain a decontamination gel for indicating contaminations of Co, Cs and Sr and to obtain good decontamination effect by cleaning the contaminations by removing a film of the decontamination gel dried-up

### DESCRIPTION OF THE RELATED ARTS

Different decontamination reagents are used for cleansing. For example, distilled products from petroleum are used to clean contaminations on surfaces of tire, break, etc. These reagents usually contain hydrocarbon solvents like methylbenzene and xylene. Yet, environmental-friendly products are developed and widely used in the modern time. As disclosed in U.S. Pat. No. 4,511,488, D-limonene is used to cleanse oil and earth on mechanical facilities. In U.S. Pat. No. 5,660,641, 2 to 8 weight percents (wt %) of terpene, or 5 to 25 wt % of anionic or nonionic surfactant, is used to effectively remove grease or tar on a surface. However, a surface having a pollution of radionuclides is not effectively cleansed. And, a solution obtained after cleansing the surface may need further treatment.

Technologies of decontamination, including chemical and non-chemical decontamination technologies, are developed. The chemical decontamination technologies use chemical reagents, such as organic acids having reduction property, chelating agents, oxidants, reductive agent, etc. These chemical reagents are soft and are used for precision machines such as reactor coolant pump (RCP). But its decontamination factor is usually small. The later non-chemical technologies are more widely used, such as electrochemical decontamination, abrading decontamination, high pressure water-jet decontamination, mechanical decontamination, etc. These methods are usually severe and may even ruin machine; though the decontamination factors may reach 103 to 104.

The above technologies are usually used for decontamination of removable material. Yet, fission products from nuclear reactions, like ⁶⁰Co, ¹³⁷Cs and ⁹⁰Sr, may be adhered on irremovable materials like industrial facilities, floor, ceiling, wall, etc. Hence, an on-the-spot decontamination method is required.

Traditional decontamination reagent for radioactive waste usually contains strong acid or alkali to improve decontamination effect, like phosphoric acid, sulfuric acid, nitric acid, fluorboric acid, potassium permanganate or sodium hydroxide. And the operation is usually processed under a high temperature. When contaminations are gradually accumulated in the decontamination reagent, its decontamination effect decreases while radioactive activity of the accumulated contaminations increases. At the minute, the decontamination reagent needs further treatment or becomes a waste. But, the treatment may not be easy owing to the complex components contained in the used decontamination reagent. And, the waste may be a great amount. All these may greatly heighten the cost.

To decrease the amount of the waste, surface protective films are developed. They are usually used as protective layers on industrial objects to prevent from contamination and collision, and thus are soft. For example U.S. Pat. No. 5,891,261 discloses (meth) acrylic acid ester combined with other polymer monomers, like less than 5% wt of carbonyl group, to form a gel. And the gel is pasted on a surface to be dried for obtaining a film. Then cold or hot water (even vapor) are spayed on the dried film to remove it.

However, the above prior arts are not suitable to radioactive pollutions. Hence, the prior arts do not fulfill all users' requests on actual use.

### SUMMARY OF THE INVENTION

The main purpose of the present invention is to obtain a decontamination reagent containing at least one polymer to be sprayed on a contaminated material for forming a film for cleaning contamination.

The second purpose of the present invention is to add evaporable organic solution to increase fluidity of gel and to control time for obtaining the film.

The third purpose is to add a colorimetric indicator in the decontamination gel to be sprayed on the contaminated material to show places of contaminations.

The fourth purpose of the present invention is to obtain a decontamination reagent having abilities of physical absorbing or chemical chelating to Co, Cs and Sr.

To achieve the above purposes, the present invention is a decontamination method of a metal surface contaminated by radioactive element, comprising steps of: (a) mixing an organic solution, more than one polymer and water to obtain a gel fluid; (b) adding a decontamination reagent and a plasticizer into the gel fluid to be fully blended then adding a solution of at least one colorimetric indicator to obtain a colorimetric decontamination gel; and (c) pasting the decontamination gel on a contaminated surface of a material to obtain a film and removing the film to decontaminate the surface. Accordingly, a novel decontamination method of a metal surface contaminated by radioactive element is obtained.

### BRIEF DESCRIPTION OF THE DRAWINGS

The present invention will be better understood from the following detailed description of the preferred embodiment according to the present invention, taken in con junction with the accompanying drawings, in which

FIG. 1 is the flow view showing the preferred embodiment according to the present invention;

FIG. 2 is the flow view show ing fabricating the gel fluid;

FIG. 3 is the flow view showing fabricating the decontamination gel;

FIG. 4 is the flow view showing fabricating the colorimetric decontamination gel;

FIG. 5 is the view showing the colors of the first state of use; and

FIG. 6 is the view showing the colors of the second state of use.

### DESCRIPTION OF THE PREFERRED EMBODIMENT

The following description of the preferred embodiment is provided to understand the features and the structures of the present invention.

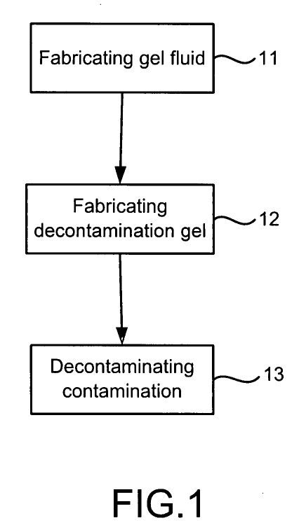

Please refer to FIG. 1, which is a flow view showing a preferred embodiment according to the present invention. As shown in the figures, the present invention is a decontamination method of a metal surface contaminated by radioactive element, comprising the following steps:

(a) Fabricating gel fluid [11]: A mixed solution with a proper ratio of an evaporable organic solution to water is obtained at first. Then at least one polymer with different weight ratio is mixed at 80 to 95 Celsius degrees (° C.) to obtain a gel fluid. With the organic solution, a density of the gel fluid is controlled and a decontamination ability to a surface of a material is increased.

Therein, the organic solution is acetylene acetone (ACAC), acetonitrile or ethanol; and the polymer is polyethylene oxide (PEO), polyacrylonitrile (PAN), polyvinyl alcohol (PVA), polyvinyl pyrrolidone (PVP), polyvinyl acetate, carboxymethyl cellulose, polyethylene oxide, polyethylene glycol, gelatin, apple pectin or arabic gum.

(b) Fabricating decontamination gel [12]: A decontamination reagent is added in the gel fluid as an absorbing agent or a chelating agent to change a density of the gel fluid for controlling time for forming a film. A plasticizer is further added to change a fragile property of the gel fluid for improving plasticity of the gel fluid. After the above added substances are fully mixed, the temperature of the mixed solution is cooled down to room temperature; and then at least one colorimetric indicator is added into an ethanol solution with a certain ratio and is added into the decontamination gel to obtain a decontamination gel having at least one colorimetric indicator. Therein, the decontamination gel is a mixture of at least one first compound, an inorganic acid and water; the first compound is diethylene triamine pentaacetic acid (DTPA), ethylene diamine tetraacetic acid (EDTA), apple pectin, prussian blue, ammonium phosphomolybdate (AMP), Ce⁴⁺/Ce³⁺, hydrogen peroxide or ferrocyanide; the inorganic acid is phosphoric acid, hydrochloric acid, formic acid or sulfuric acid; the plasticizer is tetrahydrofuran (THF), N-methyl formamide (NMF), N, N-dimethyl formamide (DMF), glycerin or phthalate ester; the colorimetric indicator is a mixture of at least one second compound and an ethanol solution; and the second compound is alizarin, phenol red (PR), arsenazo III or 2-(5-bromo-2-pyridylazo)-5-dimethylaminophenol (BrPADAP).

(c) Decontaminating contamination [13]: Pasting the decontamination gel on the contaminated surface of the material by a brush or a spraying tool. A film is thus naturally formed at a temperature between 10 and 400° C. after 3 to 24 hours (hrs). The film shows contaminated areas on the surface and contamination is soaked in the film by physical absorbing and chemical chelating. Hence, the contamination is decontaminated by removing the film. There in, the material is stainless steel, carbon steel, aluminum, copper, plastics or glass.

Accordingly, an novel decontamination method of a metal surface contaminated by radioactive element is obtained.

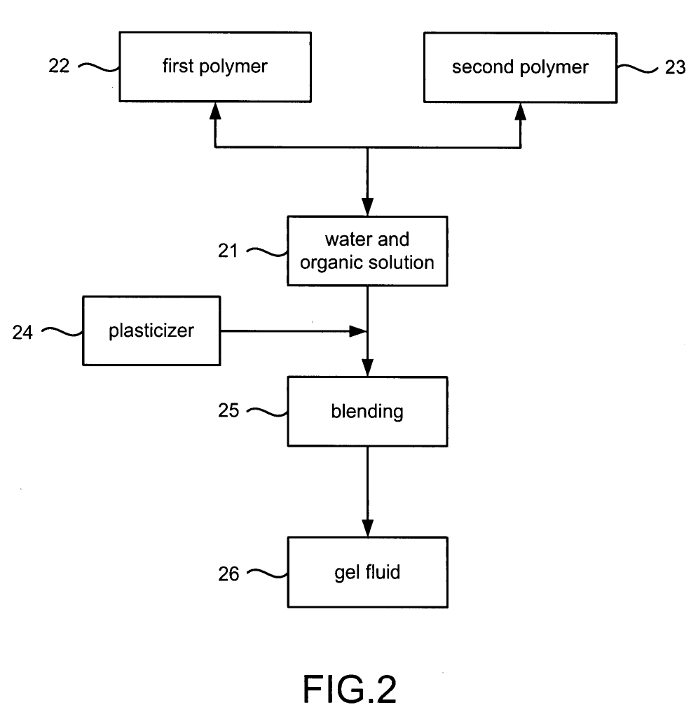

Please refer to FIG. 2, which is a flow view showing fabricating a gel fluid. As shown in the figure, on using the present invention, a mixed solution with a physical ratio of water to an evaporable organic solution [21] between 1 and 5 is obtained in a reactor. Then a first polymer [22], such as methylcellulose, is added to obtain a proper weight ratio. The methylcellulose is blended to be fully solved with temperature heated up. A condenser is then further used to prevent an evaporation of the organic solution and water. Then a second polymer [23], such as PVA, is gradually added with blending under 85° C. during 4 to 5 hrs to be fully solved into water for obtaining a proper weight ratio of the first polymer to the second polymer. Then a plasticizer [24], such as glycerin, is added at a temperature between 80° C. and 95° C. to obtain a proper volume ratio of glycerin to water. Thus, a gel fluid [26] is obtained after a continuous blending [25].

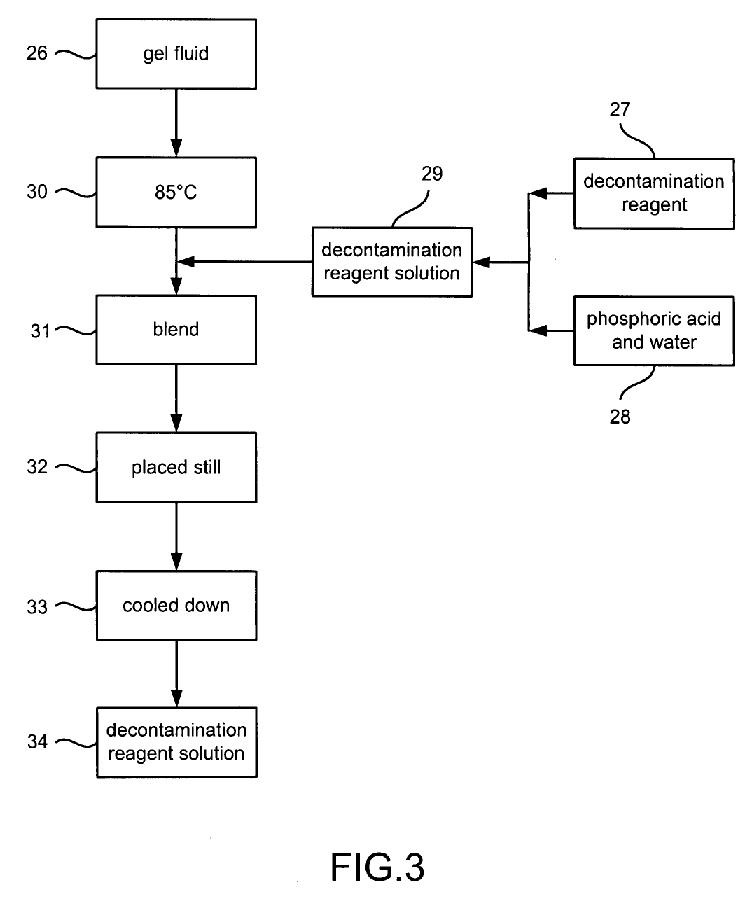

Please refer to FIG. 3, which is a flow view showing a decontamination gel. As shown in the figure, on fabricating a decontamination reagent solution, a decontamination reagent [27], such as DTPA, is solved into a solution of phosphoric acid and water [28] to be fully blended for obtaining a molar ratio of 1:8:175 for DTPA to phosphoric acid to water in the decontamination reagent solution [29]. Then 6500 volumes of gel fluid [26] is added with 200 volumes of the decontamination reagent solution [29] to obtain a ratio of 33 to 1. Then the solution is blended [31] under 85° C. [30] in the reactor. Thus, the decontamination reagent solution [34] is obtained after being placed still [32] for 1 hr to be cooled down [33] to room temperature.

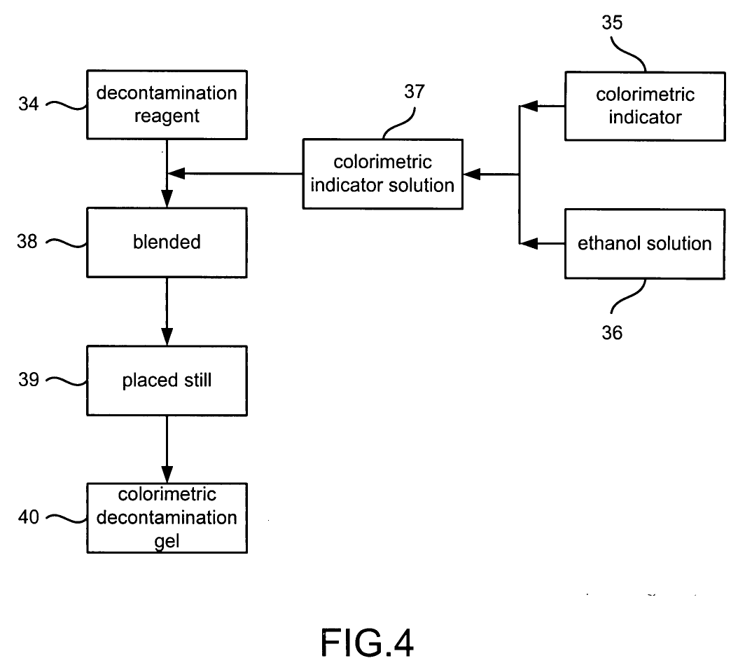

Please refer to FIG. 4, which is a flow view showing a colorimetric decontamination gel. As shown in the figure, a colorimetric indicator [35], such as allizarin, is added in to an ethanol solution [36] to obtain a colorimetric indicator solution [37] with a ratio of alizarin to the ethanol solution between 0.01 and 0.03. Then, 50 volumes of the colorimetric indicator solution [37] are mixed with 4800 volumes of a decontamination reagent [34] to obtain a proper ratio. Then the solution is blended [38] and then is placed still [39] to obtain a colorimetric decontamination gel [40].

Then, the decontamination gel is sprayed on a surface of a material. After the decontamination gel is dried up, a film is formed and radioactive substances like cobalum (Co), cesium (Cs) and strontium (Sr) are soaked in the film and are shown by the colorimetric indicator with different colors. In this way, positions of the contaminations are observed and are cleaned by removing the film. In addition, densities of the contamination are recognized by the colors.

### Color Reaction of Decontamination Gel Having Single Colorimetric Indicator

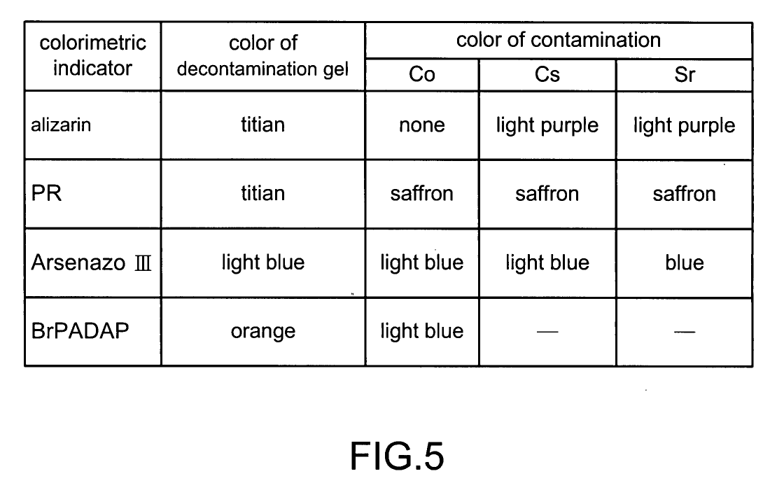

Please refer to FIG. 5, which is a view showing colors of a first state of use. As shown in the figure, different colorimetric indicators have different color reactions. At first, decontamination gels separately having colorimetric indicators are obtained. And materials of stainless steel are used to be sunk in a cleanser. Then the materials are cleansed with ultra sound before being hot-dried in an oven. After the temperature is cooled down to room temperature, solutions separately having contaminations of Co, Cs and Sr are obtained and dropped on glasses to be hot-dried. After the temperature is cooled down to room temperature, the decontamination gels separately having colormetric ring indicators are sprayed on the glasses having contaminations of Co, Cs and Sr to show different colors.

As a result, the glasses having the contaminations of Co show obvious colors by the decontamination gels having alizarin and BrPADAP; and the glasses having the contaminations of Cs and Sr show obvious colors by the decontamination gels having alizarin and arsenazo III. Hence, different decontamination gels separately having different colorimetric indicators detect materials separately having contaminations of Co, Cs and Sr for preventing pollution dispersion and protecting environment.

### Color Reaction of Decontamination Gel Having Mixed Colorimetric Indicators

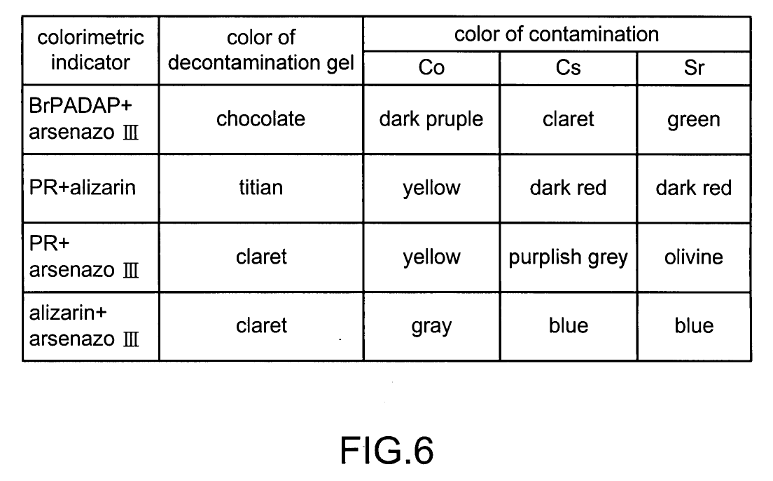

Please refer to FIG. 6, which is a view showing colors of a second state of use. As shown in the figure, a decontamination gel having more than two colorimetric indicators is used to show colors of materials having contaminations of Co, Cs and Sr. At first, two different colorimetric indicators are solved in an ethanol solution. The mixed colorimetric indicators are added to a decontamination gel. Then solutions separately having contaminations of Co, Cs and Sr are obtained and the mixed colorimetric indicators are dropped on glasses to be hot-dried to show different colors. Therein, the colorimetric indicators are BrPADAP and arsenazo III; PR and alizarin PR and arsenazo III; or alizarin and arsenazo III.

As a result, the glasses having the contaminations of Co, Cs and Sr show obvious colors by the decontamination gel having the colorimetric indicators. Hence, the decontamination gel having the colorimetric indicators detects materials having contaminations of Co, Cs and Sr for preventing pollution dispersion and protecting environment.

### Decontamination Effect of the Decontamination Gel to Materials Having Contaminations of Co, Cs and Sr

For removing contaminations of Co, Cs and Sr, a decontamination gel according to the present invention is obtained. Solutions having contaminations of Co, Cs and Sr are obtained and dropped on a glass to be hot-dried. After the temperature is cooled down to room temperature, the decontamination gel is sprayed on a glass having contaminations of Co, Cs and Sr to form a film after being dried up naturally. Thus, the contaminations of Co, Cs and Sr are cleaned by removing the film. By sinking the glass in an acid solution and analyze the acid solution afterward, a decontamination effect of the decontamination gel to materials having contaminations of Co, Cs and Sr is shown. As a result, it is shown that the decontamination gel has decontamination effects of 99%, 96% and 97% to Co, Cs and Sr separately.

To sum up, the present invention is a decontamination method of a metal surface contaminated by radioactive element, where a blend of polymers, characteristic additives and a decontamination reagent are mixed to obtain a decontamination gel for indicating contaminations of Co, Cs and Sr and to obtain good decontamination effect by cleaning the contaminations by removing a film of the decontamination gel dried-up.

The preferred embodiment herein disclosed is not intended to unnecessarily limit the scope of the invention. Therefore, simple modifications or variations belonging to the equivalent of the scope of the claims and the instructions disclosed herein for a patent are all within the scope of the present invention.

What is claimed is:

1. A decontamination method of a metal surface contaminated by radioactive element, comprising steps of:
(a) mixing an organic solution, more than one polymer and water to obtain a gel fluid;
(b) adding a decontamination reagent and a plasticizer into said gel fluid to be fully blended then adding a solution of at least one colorimetric indicator to obtain a colorimetric decontamination gel; and
(c) pasting said decontamination gel on a contaminated surface of a material to obtain a film and removing said film to decontaminate said surface.

2. The method according to claim 1,
wherein said gel fluid has a temperature between 80 Celsius degrees (° C.) and 95° C.

3. The method according to claim 1,
wherein said water and said organic solution has a physical ratio between 1 and 5.

4. The method according to claim 1,
wherein said organic solution is selected from a group consisting of acetylene acetone (ACAC), acetonitrile and ethanol.

5. The method according to claim 1,
wherein said polymer is selected from a group consisting of polyethyleneoxide (PEO), polyacrylonitrile (PAN), polyvinyl alcohol (PVA), polyvinyl pyrrolidone (PVP), polyvinyl acetate, carboxymethyl cellulose, polyethylene oxide, polyethylene glycol, gelatin, apple pectin and arabic gum.

6. The method according to claim 1,
wherein said plasticizer is selected from a group consisting of tetra hydrofuran (THF), N-methyl formamide (NMF), N, N-dim ethyl formamide (DMF), glycerin and phthalate ester.

7. The method according to claim 1,
wherein said plasticizer is mixed with said polymer at a temperature between 80° C. and 95° C.

8. The method according to claim 1,
wherein said decontamination reagent is a mixture of at least one first compound, an inorganic acid and water; and
wherein said first compound is selected from a group consisting of diethylene triamine pentaacetic acid (DTPA), ethylene diamine tetraacetic acid (EDTA), apple pectin, prussian blue, ammonium phosphomolybdate (AMP), Ce⁴⁺/Ce³⁺, hydrogen peroxide and ferrocyanide.

9. The method according to claim 8,
wherein said inorganic acid is selected from a group consisting of phosphoric acid, hydrochloric acid, formic acid and sulfuric acid.

10. The method according to claim 8,
wherein a molar ratio of said decontamination reagent to said inorganic acid to water is 1 to 8 to 175.

11. The method according to claim 1,
wherein said colorimetric indicator is a mixture of at least one second compound and an ethanol solution;
wherein said second compound is selected from a group consisting of alizarin, phenol red (PR), arsenazo □ and 2-(5-bromo-2-pyridylazo)-5-dimethylaminophenol (BrPADAP).

12. The method according to claim 11,
wherein said colorimetric indicator and said ethanol solution is mixed to obtain a ratio between 0.01 and 0.03.

13. The method according to claim 1,
wherein said decontamination gel is exposed in air for 3 to 24 hours at a temperature between 10° C. and 40° C. to obtain said film.

14. The method according to claim 1,
wherein said film has a decontamination efficiency, which is greater than 96%, to a contamination containing an element selected from a group consisting of cobalum (Co), cesium (Cs) and strontium (Sr); and

15. The method according to claim 1,
wherein said material is selected from a group consisting of stainless steel, carbon steel, aluminum, copper, plastics and glass.

16. The method according to claim 1,
wherein said colorimetric indicator colorizes contaminations on said surface of said material and thus shows positions of said contaminations.

17. The method according to claim 1,
wherein a physical ratio of said decontamination reagent to said gel fluid in a mixed solution is 1 to 33.
